(19) United States
(12) Patent Application Publication
(10) Pub. No.: US 2008/0194127 A1
(43) Pub. Date: Aug. 14, 2008

(54) Electrical Flat Strip Conductor For Motor Vehicles

(75) Inventors: Rolf Stracke, Lorrach-Stetten (DE); Heinz-Georg Gottschlich, Erkelenz (DE)

Correspondence Address: BROMBERG & SUNSTEIN LLP, 125 SUMMER STREET, BOSTON, MA, 02110-1618, US

(73) Assignee: Auto Kabel Managementgesellschaft mbH, Hausen i.W. (DE)

(21) Appl. No.: 11/815,145

(22) PCT Filed: Jan. 12, 2006
(86) PCT No.: PCT/EP06/50187

§ 371 Date: Jul. 31, 2007

(30) Foreign Application Priority Data
Feb. 3, 2005 (EP) 05002211.0
Jun. 13, 2005 (EP) 05012641.6

(51) Int. Cl. H01R 25/16; H01R 43/00; H01R 35/02

(52) U.S. Cl. 439/120; 174/133 R; 29/825

(57) ABSTRACT

The invention relates to an electrical flat strip conductor of aluminium and of profiled cross-section for motor vehicles. To make it possible for processing to be easy, it is proposed that the flat strip conductor is formed from soft-annealed aluminium sheet unwound from at least one coil.

The invention relates in general to an electrical flat strip conductor of aluminium and of profiled cross-section for motor vehicles. The invention also relates in general to a method of producing an electrical flat strip conductor of this kind for motor vehicles and to the use of aluminium flat strip for flat strip conductors.

It is normal practice nowadays for electrical flat strip conductors to be produced from copper or e-aluminium, i.e. AlMgSi 0.5. The use of these materials is proposed on page 632 of the Aluminium Taschenbuch, Vol. 3, 15th edition, Aluminium Verlag.

In motor vehicle production, such as car production and lorry production, shipbuilding and railway vehicle production, what is conventionally used for making the electrical connections within the vehicles is copper, due to its high conductivity. However, the disadvantage arises that copper cables are dear, due to the high price of raw materials. Also, particularly in the case of conductors of large cross-section and considerable length, copper is a disadvantage due to its high weight.

Both in car design and in truck design, attempts to reduce the weight of vehicles, in order, amongst other things, to save fuel by this means, goes back a long way. However, when copper cables are used, the only way of reducing weight is by making the cross-sections of the cables smaller, which leads to problems with the current-carrying capacity of the cables.

It is already known for flat strip cables to be fitted as battery cables in motor vehicles. In this way, DE 4 210 202 A1 for example describes a flat strip cable for use as a battery cable. This flat strip cable is formed by extruding a battery cable consisting of a stranded cable. The flat strip cable described is a copper cable and has the above-mentioned disadvantages.

A flat strip cable for use in motor vehicle construction is also known from JP P2001-291433A. This flat strip cable may be formed from a plurality of strips arranged next to one another. These strips may be made of copper or e-aluminium. The outer covering is of laminated aluminium/polyethylene comprising an aluminium strip and an insulator such as polyethylene terephthalate. Provision is also made for connecting members for attaching the flat strip conductor to the motor vehicle.

In the case of the flat strip cables disclosed, the aluminium used is solely e-aluminium. The conductors are produced from extruded aluminium wires. However, in the course of the extrusion twists are produced in the flat strip, which means that it is only with considerable effort that subsequent stages of production can be automated. Also, conventional aluminium cables of cross-sections greater than 80 mm² can no longer be wound into a coil after they have been processed because the aluminium used is not soft enough.

The disadvantages pointed out above create the technical problem of providing an electrical flat strip conductor for motor vehicles which can be processed easily.

This technical problem is solved in accordance with the invention by forming the electrical flat strip conductor from soft-annealed aluminium strip unwound from at least one coil. In accordance with the invention, use may be made of both aluminium strips and aluminium sheets. In the production of aluminium, the aluminium is generally wound into a coil (spool spindle) after it has been rolled or extruded. In accordance with the invention, it has now been realised that the aluminium strip wound into the coil can easily be processed into a flat strip conductor if the aluminium strip is soft-annealed beforehand. Once the aluminium strip has been soft-annealed, it can easily be unwound from the coil and subjected to further processing at little cost or effort. Because the soft-annealed aluminium can easily be wound into or from coils, the flat strip conductor can be produced as material sold by the metre.

Once an aluminium sheet has been rolled, it is preferably of widths of between 50 cm and a few metres. Wide aluminium sheets of this kind are wound onto coils and transported in this form. What are required for flat strip conductors in motor vehicles are strip widths of, preferably, 10 to 40 mm. It is therefore proposed that the flat strip conductor is formed from aluminium sheet which is unwound from a coil and divided into individual conductors.

Hence, in this embodiment the wide aluminium sheet is unwound from a coil and divided in a succeeding processing step. After the dividing, the individual narrow conductors may be rewound into coils. The dividing may be performed by cutting, sawing, welding, laser cutting, water-jet cutting or other shapes cutting or shape cuttung processes. What is particularly advantageous in this case is cutting with blades, lasers or water jets.

It is also preferable for the flat strip conductor to be produced by rod extrusion from a soft-annealed aluminium semi-finished product, such for example as a cable, a stranded cable or a profile. The step of dividing the flat strip is dispensed with in this case.

Because of the use of aluminium strips, the flat strip conductors may be profiled as desired. What are preferred are rectangular, square or U-shaped profiles.

It has also been found that, for use as flat strip conductors, it is advantageous for partial use to be made of Al 99.5%, or a purer grade, e.g. Al 99.7%, or of alloys thereof.

In an advantageous embodiment, it is proposed that the flat strip conductor is in an as-produced state of 0. This is the as-produced state of the soft-annealed semi-finished product of aluminium. In this state it is possible for the flat strip conductor to be moved in any direction in space. The flat strip conductor formed in this way can thus be bent easily and a cable loom of almost any desired shape can be produced in this way. The 0 state also gives the material good conductivity. With regard to the mechanical properties of the semi-finished product, the 0 state is described in DIN EN 485-2.

The soft-annealing of the aluminium strip has a beneficial effect on its electrical properties. In advantageous embodiments it is therefore proposed that the aluminium used has, in the flat strip conductor, a conductivity of from 30 to 37 m/(ohm*mm²) . The winding of the aluminium strip into and from a coil, and the re-winding of the cut or extruded flat strip conductor into a coil and the subsequent unwinding from the coil to feed to an extruder is preferably simplified by the fact that the flat strip conductor allows a stretch of at least 30%. This stretch, which is preferably more than 35%, on the one hand makes it possible for winding and unwinding to be easy and on the other hand allows cable looms to be shaped in any desired directions in space.

What is more, in a further advantageous embodiment it is proposed that the flat strip conductor has a tensile strength of approximately 60 to 80 N/mm²+/−50%. This tensile strength on the one hand permits automatic processing, and in particular extrusion with an insulator, and on the other hand allows easy bending to form a cable loom having bends in any directions in space.

In a further advantageous embodiment, the flat strip conductor may have connecting pins applied to its surface to form points for electrical contact. The connecting pins may be arranged at any desired points along the flat strip conductor. The connecting pins allow the electrical potential to be tapped off easily along the flat strip conductor for supply to electrical loads or points of measurement within the motor vehicle. A centre terminal point may preferably be formed to act as a terminal point for jump-starting. A terminal point for jump-starting may be formed at any point in the motor vehicle.

In an advantageous embodiment, it becomes particularly easy for a connection to be made by the fact that the connecting pin is at least partly formed from brass or alloys thereof. As well as this, copper, aluminium, steel or other conductive materials are possible for the connecting pin. It is also proposed that the connecting pin is connected to the flat strip conductor by means of a friction welding process. It is preferable for torsion friction welding or multi-orbital friction welding to be employed. The friction welding produces frictional heat and pressure and this means that the layer of aluminium oxide on the flat strip conductor is broken open and there is a reduction in the contact resistance of the electrical contact between the connecting pin and the flat strip conductor. In the friction welding, a depth of penetration of less than 3 mm, and preferably of 1 mm, is reached. Because the material of the flat strip conductor is very soft, a suitable pressure has to be employed in the friction welding so that the connecting pin is not driven directly through the flat strip conductor. The connecting pin is preferably provided with a polygon portion, and preferably with a square portion, which on the one hand acts as a gripping point for a tool in the friction welding and on the other hand, in subsequent over-moulding, provides a secure fixing point for the over-moulding process.

It is further proposed that at least one connecting pin is arranged between the ends of the flat strip conductor. What this means is that a connecting pin to allow the potential to be tapped off to supply electrical loads or to allow a point of measurement to be connected-in may be arranged at any desired point along the flat strip conductor. The connecting pins may be arranged on any desired face of the flat strip conductor. The connecting pins are preferably arranged on the wide faces of the flat strip conductor. This also enables them to be produced as terminal points for jump-starting.

It is proposed in an advantageous embodiment that the cross-section of the flat strip conductor is at least 16 mm². What is particularly advantageous in this case is for there to be a ratio of 1 to 5 between height and width, such for example as a height of 4 mm and a width of 20 mm.

Known aluminium flat strip conductors are all produced by extrusion and have an ability to stretch of approximately 25%. On the one hand, these extruded flat strip conductors are not suitable for automatic further processing because the extrusion produces twists in the material and on the other hand they cannot readily be wound into coils.

The aluminium flat strip conductors known from DIN 43670 are formed from an aluminium core and an outer sheath of copper and therefore have the known disadvantages of copper cables. To allow the copper outer sheath to be obtained, the aluminium flat strip conductors have to be subjected to a further stage of electrochemical processing.

By contrast, the invention proposes a method in which a soft-annealed aluminium semi-finished product is unwound from a coil and in which a flat strip conductor is formed from the aluminium semi-finished product which is unwound. The aluminium semi-finished product may be aluminium sheet or aluminium strip. Such materials are supplied by an aluminium manufacturer in widths of between 50 cm and several metres. The wide aluminium sheet is already soft-annealed and is supplied wound into a coil. To produce the flat strip conductors which are suitable for use in motor vehicles, the aluminium sheet is unwound and divided into flat strip conductors of the appropriate width. For the dividing, what is preferred is cutting by blades, a laser or a water jet. It is also possible for the dividing to be performed by means of sawing or welding or other shape cutting or shape-cutting processes. The aluminium semi-finished product may also be an aluminium cable or a stranded cable. The latter is extruded and a flat strip conductor is thus formed.

Once the aluminium sheet has been divided into the single flat strip conductors then, in an advantageous embodiment, the divided flat strip conductor is wound into a coil. This winding is particularly easy with the soft-annealed aluminium and has only an insignificant adverse effect on the further processability of the flat strip conductor.

For an insulator to be applied, it is proposed in an advantageous embodiment that the flat strip conductor which has been wound into the coil is unwound and coated with an insulator. This can be done by extrusion, varnishing or lacquering, lamination, over-moulding or other processes for insulating conductors.

For extrusion, it is also proposed that the flat strip conductor first is brought to the extruder by means of rollers via a crawler arrangement.

To finish off the insulated flat strip conductor, it is proposed in an advantageous embodiment that, after being insulated, the said flat strip conductor is cut to length. It is also possible for the flat strip conductor to be coiled again after being insulated. This makes it easier for the conductor to be transported after being insulated. After the cutting to length, a cable loom can, in a further advantageous embodiment, be formed by bending the flat strip conductor in any directions in space. Due to the low hardness and high ability to stretch achieved by means of the soft annealing, the bending is particularly easy. Cable looms of almost any desired shape can be produced using the flat strip conductor according to the invention.

To provide tap-off points for electrical loads or measuring devices along the flat strip conductor, it is proposed that connecting pins are applied to the flat strip conductor, after it has been cut to length, by joining by material connection. For this purpose it is proposed that the insulator is cut open by means of suitable processes, such for example as cutting, lasering, etc., and that the connecting pin is applied to the connecting points from which the insulation has been removed. Joining techniques may preferably be welding, and in particular rotary friction welding, multi-orbital welding, torsional ultrasonic welding or laser welding.

The invention also relates to the use of a soft-annealed aluminium flat strip which has been wound into a coil as a flat strip conductor in a motor vehicle. What in particular is proposed is the use of a flat strip conductor produced by a process as described above or of a flat strip conductor having the properties and characteristics described above.

The invention will be described in detail below by reference to drawings showing embodiments. In the drawings:

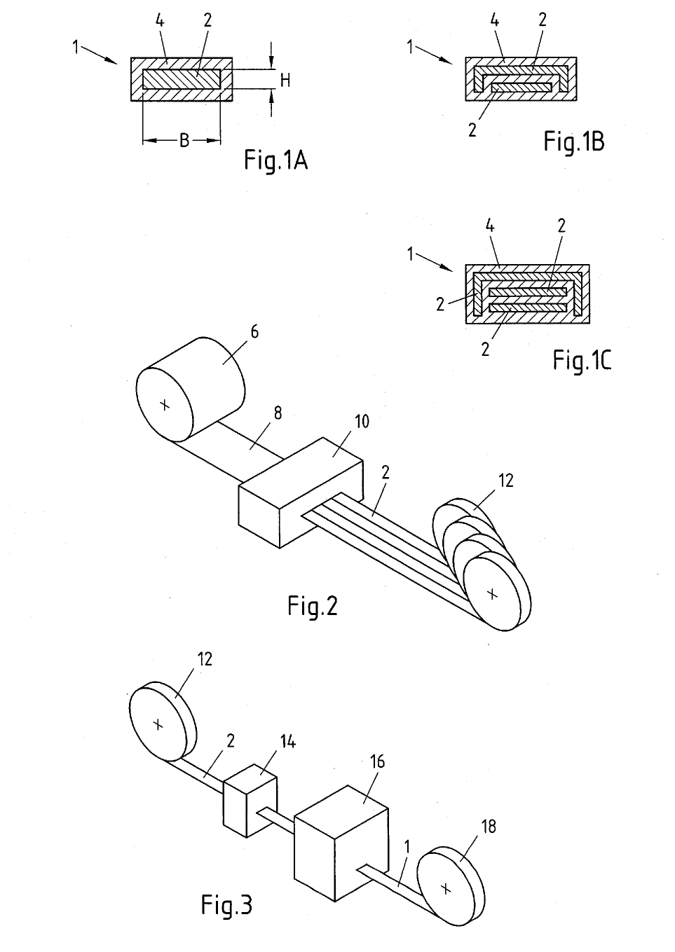

FIGS. 1A to 1C show cross-sections through a flat strip conductor according to the invention.

FIG. 2 shows a first step in the method of producing flat strip conductors from an aluminium strip.

FIG. 3 shows a second step in production for the extrusion of the flat strip conductor.

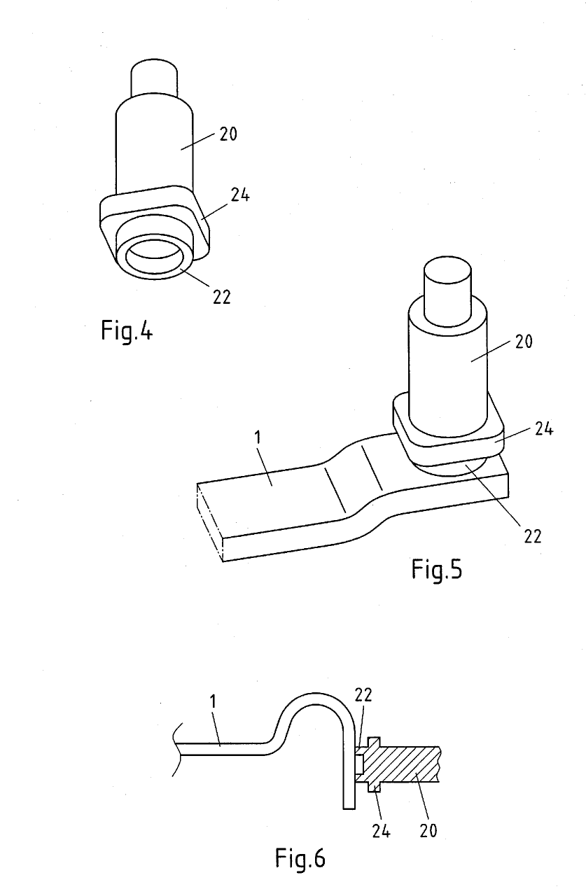

FIG. 4 shows a connecting pin.

FIG. 5 shows a connecting pin welded onto a flat strip conductor.

FIG. 6 shows a connecting pin welded on at a face at an extremity.

FIG. 1A shows a cross-section through an electrical flat strip conductor 1 which is formed from an aluminium conductor 2 and insulation 4. The aluminium conductor 2 is made from a soft-annealed aluminium strip. The aluminium is preferably in a 0 state. This property gives the aluminium good conductivity and, what is more, good properties for absorbing vibration in vehicle crashes and to allow the flat strip conductor to be bent when cable looms are made up. A conductivity of 34 to 36 m/ohm*mm² is preferred in this case. The aluminium is also processed in such a way that it comprises a tensile strength of 60 to 80 N/mm² and, as a particular preference, of 75 N/mm². The ability to stretch is preferably more than 30% and, as a particular preference, more than 35%, which gives good processability. The cross-section of the aluminium core 2 is preferably 80 mm². The height H is preferably 4 mm and the width B is preferably 20 mm. Also preferred is a ratio of 1:5 between height and width.

The insulating material 4 is preferably a polyethylene or some other conventional insulating material such for example as PVC, PUR, laminate or lacquer. The said insulating material 4 may be applied to the aluminium conductor 2 by extrusion and preferably by tube extrusion. Other insulating processes are also possible. There are no twists in the aluminium conductor 2 according to the invention, the result of which is good processability. Also, due to the soft-annealing of the aluminium conductor 2, the value of its ability to stretch is more than 25%.

FIG. 1B shows a cross-section through a flat strip conductor 1 having two aluminium conductors 2. The aluminium conductors 2 have a U-shaped profile and a rectangular profile.

FIG. 1C is a further cross-section through a flat strip conductor 1. Two rectangular aluminium conductors 2 are arranged as layers in a U-shaped profile of a first aluminium conductor 2.

FIG. 2 shows a first step in the production of a flat strip conductor according to the invention. Aluminium sheet 8 is shown wound into a coil 6. The thickness of the aluminium sheet 8 is preferably 2 to 10 mm and, as a particular preference, 4 mm. The aluminium sheet 8 is soft-annealed in production, thus giving the properties mentioned above. The width of the aluminium sheet 8 unwound from the coil 6 is preferably 2 m. The aluminium sheet 8 is fed to a dividing arrangement 10. In the dividing arrangement 10 the aluminium sheet 8 is divided into the aluminium conductors 2. The dividing may be done by means of blades in this case. It is also possible for the aluminium sheet 8 to be divided by lasering or by water-jet cutting or by sawing. All other non-stock-removing or stock-removing dividing processes are also a possibility. The aluminium conductors 2 are rewound into respective fresh coils 12. Because of the high extensibility this rewinding is readily possible. Unwinding from the fresh coils 12 is likewise possible without any problems. The individual fresh coils 12 can be transported easily and make it possible for handling to be easy in the production process.

FIG. 3 shows the extrusion of the single aluminium conductors 2 into compact flat strip conductors 1. In cases where flat strip conductors 1 are arranged in layers, as shown in FIGS. 1B and 1C, each individual aluminium conductor 2 may firstly be insulated and then joined to the others to form a single flat strip conductor 2. In this case, the aluminium conductor 2 is unwound from the fresh coil 12 and fed to the extruder 16 via at least one crawler 14. It is also possible for a plurality of aluminium conductors to be fed to the extruder and to be joined to form an insulated flat strip conductor 2 in one step.

After the extrusion, the flat strip conductor 1 is again coiled into a coil 18. By means of the crawler 14, the bends in the aluminium conductor 2 caused by the coiling are straightened and an even feed to the extruder 16 thus becomes possible. In the extruder 16, the aluminium conductor 2 is brought to the extruding head by means of suitable guides.

Suitable guiding means are needed because the material is soft. In the extruder 16, an insulating material can be extruded onto the aluminium conductor 2. After the extrusion, the flat strip conductor 1 is either wound into a further coil 18 or is finished off directly. The finishing off may be performed by cutting to length, bending, fitting of contacts or other processing steps.

From the coil 18, the flat strip conductor 1 may be unwound again and finished off. In the process, it may firstly be cut to the desired length and then bent into a cable loom by suitable bending arrangements. Because the aluminium is soft, the bending involves relatively little effort.

FIG. 4 shows a connecting pin 20 serving as a terminal point on the flat strip conductor. The pin 20 is preferably made of brass, steel, copper or other conductive materials. At its end, the connecting pin 20 has a polygonal, and preferably four-sided, formation 24. The formation 24 may be used as a support point for a tool, and in particular as a point at which a friction welding tool can take a grip.

FIG. 5 shows a connecting pin which is mounted on a flat strip conductor 1. The connecting pin 20 has been welded to the flat strip conductor 1 by a welding or soldering or brazing process in this case. The depth to which the connecting pin 20 penetrates into the flat strip conductor 1 when they are connected together is preferably a maximum of 1 mm. After the welding, soldering or brazing, the polygonal formation 24 can be used as a holding member for a subsequent over-moulding or embedding process. The connecting pin 20 may be arranged on the flat strip conductor 1 at any desired point and is not necessarily only at the end of the flat strip conductor 1. A central tap-off point, particularly in the form of a terminal point for jump-starting, is also possible.

When thin sheet or strip is being used, welding the connecting pin to the face at the extremity may present problems. In the first place, it is proposed that the face at the extremity is reshaped by stamping in such a way that the face at the extremity has an enlarged area for contact. In this way, the face at the extremity may for example be compressed with the help of a ram. The face at the extremity can then be matched to the circular or polygonal shape of a shaping die. It is also possible for the face at the extremity to be enclosed in a sleeve in order to obtain an enlarged area for contact for the connecting pin.

It is also possible for the connecting pin to be connected in the region of the face at the extremity in the manner shown in FIG. 6. For this purpose, the flat strip conductor 1 is bent in the region of the face at the extremity. Any angle position is possible here. In the present case, the bending is such that, in the region of the face at the extremity, the wide face of the flat strip conductor 1 is substantially perpendicular to the path followed by the flat strip conductor 1 in the region before it is reached.

The ring 22 of the connecting pin 20 can be welded, soldered or brazed to the wide face.

1-21. (canceled)

22. Electrical flat strip conductor of aluminum and of profiled cross-section for motor vehicles,
wherein
the flat strip conductor is formed from soft-annealed aluminum strip unwound from at least one coil and has a stretch of at least 30%.

23. Electrical flat strip conductor according to claim 22, wherein the flat strip conductor is a battery cable.

24. Electrical flat strip conductor according to claim 22, wherein the flat strip conductor comprises a cross-section of at least 16 mm².

25. Electrical flat strip conductor according to claim 22, wherein the flat strip conductor is produced from aluminum strip which is unwound from a coil and divided into single conductors.

26. Electrical flat strip conductor according to claim 22, wherein the flat strip conductor is formed from the aluminum strip by extrusion.

27. Electrical flat strip conductor according to claim 22, wherein the flat strip conductor is at least partly formed from Al 99.5% or alloys thereof.

28. Electrical flat strip conductor according to claim 22, wherein, with regard to its mechanical properties, the flat strip conductor is in an as produced state of 0.

29. Electrical flat strip conductor according to claim 22, wherein the flat strip conductor has a tensile strength of approximately 60 to 80 N/mm²+/−50%.

30. Electrical flat strip conductor according to claim 22, wherein the flat strip conductor has a conductivity of approximately 30 to 37 m/(ohm* mm²).

31. Electrical flat strip conductor according to claim 22, wherein at least one connecting pin is applied to the surface of the flat strip conductor as a point for electrical contact.

32. Electrical flat strip conductor according to claim 22, wherein the connecting pin is at least partly formed from brass, copper or alloys thereof.

33. Electrical flat strip conductor according to claim 22, wherein the connecting pin is connected to the flat strip conductor by material connection.

34. Electrical flat strip conductor according to claim 22, wherein at least one connecting pin is arranged between the ends of the flat strip conductor.

35. Method of producing an electrical flat strip conductor for motor vehicles,
in which at least one soft annealed aluminum semi-finished product is unwound from a coil;
in which a flat strip conductor is formed from the unwound aluminum semi-finished product; and
in which the flat strip conductor is formed with a stretch of at least 30%.

36. Method according to claim 35, wherein the flat strip conductor is formed by dividing the aluminum semi-finished product and in that the flat strip conductor is wound into a coil after the dividing.

37. Method according to claim 35, wherein the flat strip conductor is formed by extrusion of the aluminum semi-finished product and in that the flat strip conductor is wound into a coil after the extrusion.

38. Method according to claim 36, wherein the flat strip conductor is unwound from the coil and coated with an insulator.

39. Method according to claim 38, wherein, before and after being insulated, the flat strip conductor is cut to length.

40. Method according to claim 39, wherein, after the cutting to length, the connecting flat strip conductor is bent in such a way that a cable loom is formed for a motor vehicle.

41. Method according to claim 39, wherein a connecting pin is applied to the flat strip conductor, after it has been cut to length, by joining by material connection.

42. Use, in particular by a method according to claim 35, of a soft-annealed aluminum flat strip conductor which has been wound into a coil, as a flat strip conductor, in particular according to claim 1, in a motor.
